(19) United States
(12) Patent Application Publication
(10) Pub. No.: US 2011/0178640 A1
(43) Pub. Date: Jul. 21, 2011

(54) Building Equipment Control System

(75) Inventor: Frank Schmidt, Altkirchen (DE)

(73) Assignee: EnOcean GmbH, Oberhacing (DE)

(21) Appl. No.: 12/521,456

(22) PCT Filed: Dec. 4, 2007
(86) PCT No.: PCT/EP2007/063306

§ 371 Date: Apr. 7, 2011

(30) Foreign Application Priority Data
Dec. 28, 2006 (DE) 102006061705.3

(51) Int. Cl. G05B 15/02

(52) U.S. Cl. 700/275

(57) ABSTRACT

A building equipment control system with at least one partial system comprising a sensor and/or an actuator, each of which is coupled to a processing unit and which incorporates a wireless signal transmission and reception unit that is coupled to the processing unit.

The invention concerns a building equipment control system with at least one partial system comprising a sensor and/or an actuator.

A building equipment control system is used, for instance, in building automation. Building automation, for instance, includes heating or cooling a room in accordance with an external temperature, or sun-protection measures such as automatic blinds that are operated in accordance with the incoming solar radiation. The monitoring of the closure of doors and windows using door and window contacts, as well as monitoring the state of door and window locks, are also relevant to building automation. Thus room heating can be controlled in reaction to the closure of a window. Against the background of making economical use of energy resources it is, for instance, appropriate to turn down or entirely shut off room heating when a window is open. It is also possible for doors to be locked automatically by means of a building equipment control system. Thus self-acting locks are known for use in door and window locks, moved by means of a drive of an electrical or mechanical nature. For this purpose sensors are installed in the building units, for instance in the individual rooms, that measure the room temperature or determine whether the window in the room is closed. These sensors are supplied with electrical power over wires, or transmit an electrical signal by means of these wires to a central control unit. The central control unit compares the transmitted value with a specified value, generates a signal, and transmits this to an actuator, again over wired connections. The actuator operates on a functional unit within the building equipment. Thus a functional building equipment unit, room heating for instance, is switched off by the actuator when a window is open.

The work required to install a building equipment control system of the type mentioned above is considerable. The reason for this is that every subsidiary system that requires monitoring—such as the lock of a window or the temperature of a room—must be determined by a sensor that is assigned to the location concerned. Wires must be connected between the sensor and the central control unit so that the signals can be transmitted. In larger buildings this can be a distance of several hundred metres or more. The same applies to the actuators. The actuators, too, are connected to the central control unit by means of wires between the central control unit and the actuator. The provision of wired connections of this type represents a high proportion of the installation work.

The purpose of the invention is therefore to provide a building equipment control system whose installation requires significantly less effort.

This purpose is fulfilled it arrangement of claim 1, and is favourably further developed by the arrangements of the dependent patent Claims 2 to 8.

A building equipment control system is proposed having at least one partial system comprising a sensor and/or actuator. The sensor and/or actuator are coupled to a processing unit that is also comprised within the partial system. The partial system, moreover, incorporates a wireless signal transmission and reception unit that is coupled to the processing unit.

The task of the sensor here is to acquire physical parameters from its environment and to convert them into an electrical signal. This electrical signal thus provides a reference to a specific physical parameter such as, for instance, a temperature.

The task of the actuator here is to convert an electrical signal into a physical parameter. An actuator can thus, for instance, be a component of an air-conditioning or heating system, or can itself be the air-conditioning or heating system, in which case the electrical signal mentioned above provides an input value to the air-conditioning system. In a simple case this is a command to switch on or to switch off that leads to a change in temperature provided by the actuator or by the action that is triggered by the actuator.

Signals that are transmitted from the sensor to the processing unit have already been processed in the partial system by means of the processing unit. Transmission of the sensor signals to a central control unit is therefore not always essential. In this case the processing unit embodies a specified rule that sends a control signal to the actuator in accordance with the sensor signal.

The processing unit can carry out analog or digital processing on the incoming signals. The processing of the incoming signals is favourably carried out digitally, as this permits the processing unit to represent significantly more complex interrelationships while consuming little energy. The processing unit therefore favourably incorporates an analog/digital converter that changes the naturally analog signals from the sensor into digital signals. As an alternative, the sensor can itself incorporate an analog/digital converter.

In an alternative embodiment, a partial system comprises only a sensor or an actuator. For full functionality, this embodiment requires at least one second partial system, where the first partial system comprises the sensor and the second partial system comprises the actuator. To achieve full functionality, the two partial systems must exchange this data between them. In this case, the sensor signal or the control signal is transmitted to the other partial system by means of the wireless signal transmission and reception unit. In this case the first partial system, which incorporates the sensor, is arranged in such a way that the sensor is used in an optimum manner and can acquire a value. The second partial system, comprising the actuator, is at some physical distance from the first partial system, and this arrangement is selected in such a way that the actuator operates in an optimum manner on a functional unit of the building equipment.

The functional unit in the building equipment is, for instance, a heating system for a room. This might be a single radiator mounted on a wall, or may be a complex heating system that carries out particular actions when triggered by the actuator. The actuator can, for instance, cause a radiator thermostat to close because a sensor that monitors whether the room a window is closed determines that a window is open. The range of applications is very broad, and the examples mentioned can therefore only provide a glimpse of the possibilities without thereby restricting the application to those described.

This means that the sensor values can be acquired at any time, and can be transmitted through the wireless signal transmission and reception units to the second partial system. The second partial system receives the sensor values, processes them in accordance with the specified rules, and transmits the results in the form of a signal to the actuator. Alternatively, the sensor values are evaluated immediately by the processing unit in the first partial system, so that the result of this evaluation can be transmitted by means of the wireless signal transmission and reception units to the second partial system. Both partial systems are set up in such a way that evaluation or processing of the sensor values can be carried out at both partial systems. The data exchange is set up in such a way that a distinction can be made between sensor values and signals that represent the result of processing the sensor values.

Favourably, partial systems with a variety of types of energy supply may be considered. Mains-powered energy supply is one possibility, in which the partial system is connected to the building's electrical power network, and is supplied with energy from there. This is of particular advantage to partial systems that, being installed close to the functional unit of the building equipment, can easily and without additional installation work be connected to the electrical power network of the building, such as a partial system that consists only of an actuator. Power supply that is independent of the mains may also be considered, whereby, for example, an electrical energy store and/or energy converter that supplies the electrical energy to operate the partial system is provided. The partial systems with mains-powered energy supply are favourably fitted with a transmission and reception unit, and are thereby suitable for carrying out bidirectional radio communication. In order to save electrical energy, it is favourable for those partial systems whose power supplies are independent of the mains merely to implement unidirectional data exchange, i.e. unidirectional radio communication. This means that a partial system that is independent of the mains according to this implementation can only transmit or only receive data. Favourably these are, for instance, partial systems with sensors, since this means that during installation the independence of mains power is helpful in that the partial system can be installed optimally in terms of the conditions of the physical environmental that are to be determined.

It is also possible, particularly for partial systems with mains-powered energy supply, due to the fact that they are installed physically close to the functional units of the building equipment, and that these are in any case frequently connected to a building data bus system, to provide equipment that permits data transfer over a data bus system provided for this purpose. This permits a favourable combination of radio data transmission with wired data transmission.

In a favourable embodiment, the wireless signal transmission and reception unit is designed in such a way that it is integrated with other partial systems in order to operate bidirectional data exchange. This offers the advantage that the individual partial systems constitute a network. The individual partial systems are located in and on the building at their place of application. Because each partial system is situated at a different place of application, and possibly furthermore has each a different purpose, the partial systems are distributed throughout an entire building. Information that is to be sent from a first partial system to a second partial system is therefore carried in the network through other partial systems until it reaches the second partial system.

The transmission range that is necessary at each partial system in order to transfer information in the manner described above can thereby be significantly reduced, as the information is relayed from one partial system to another. A network of this sort is formed in such a way that the information is relayed or transmitted in each case to the nearest other system, and that this system, unless the information is in fact intended for it, in turn relays the information to its nearest neighbour. The more densely such a network is formed, which means the smaller the distance is between the individual systems, the more secure the data transmission is. This security is not only a function of the reliability of the transmission itself and the quality of the transmission, but also on the immunity of the network to interference or to eavesdropping. Because a single partial system only has a small transmission range, this radio signal can only be listened to with difficulty from a remote point. This also makes deliberate interference with the network more difficult. In order to achieve deliberate interference, such as transmitting a command for opening a door lock to the actuator in a single partial system, the interfering transmitter requires a large amount of information that it cannot, due to the difficulty of eavesdropping, obtain.

A further advantage of the short ranges can be seen in the fact that each individual partial system requires less energy for signal transmission, as the signal only has to be sent to a neighbouring partial system. Significantly more energy would be required to transmit the signal directly to the remote second partial system. This is particularly advantageous when only limited energy resources are available for the power required by the individual systems. Limited supplies of power are, for instance, found when batteries or accumulators store and make available the energy at the partial systems.

In a favourable embodiment it is proposed that the partial system is coupled to an energy converter that converts non-electrical energy in the environment into electrical energy. The energy converter is here located physically close to the partial system, or even constructed together with the partial system.

A favourable embodiment proposes that in order to store the electrical energy provided by means of the energy converter, an energy store is provided that is coupled to the partial system. This is associated with the advantage that the stored electrical energy is then available when the partial system requires energy for transmitting or receiving information, or in order to operate the actuator or the sensor. In addition, it is in this way favourably possible to compensate for the fact that convertible energy in the environment is frequently not available at the precise times when it is required by the individual partial system.

The invention is described in more detail below on the basis of an example of an embodiment and with the aid of six figures. They show:

FIG. 1 a partial system in a building equipment control system with one sensor and one actuator,

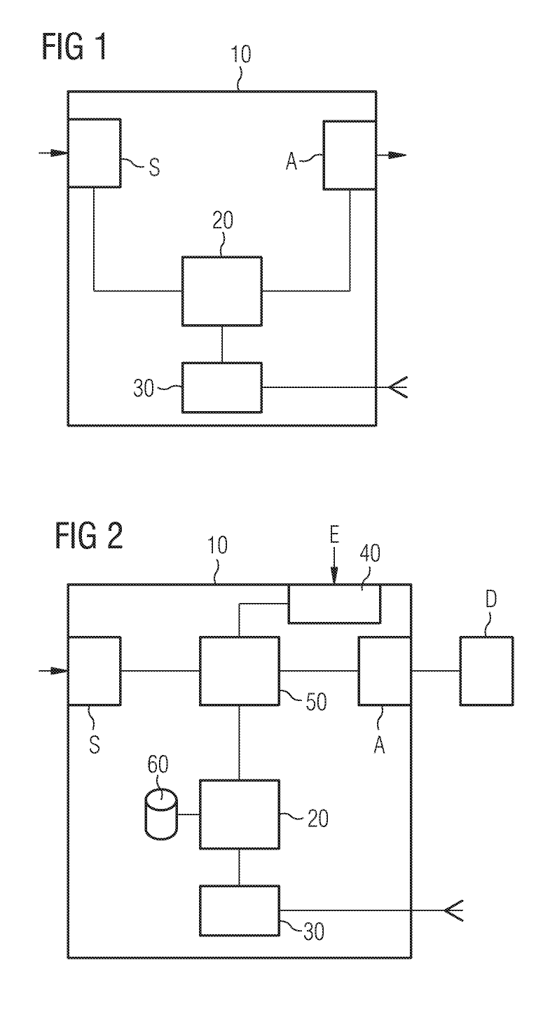

FIG. 2 the partial system of a building equipment control system from FIG. 1 with an energy converter, an energy store unit and a data store unit,

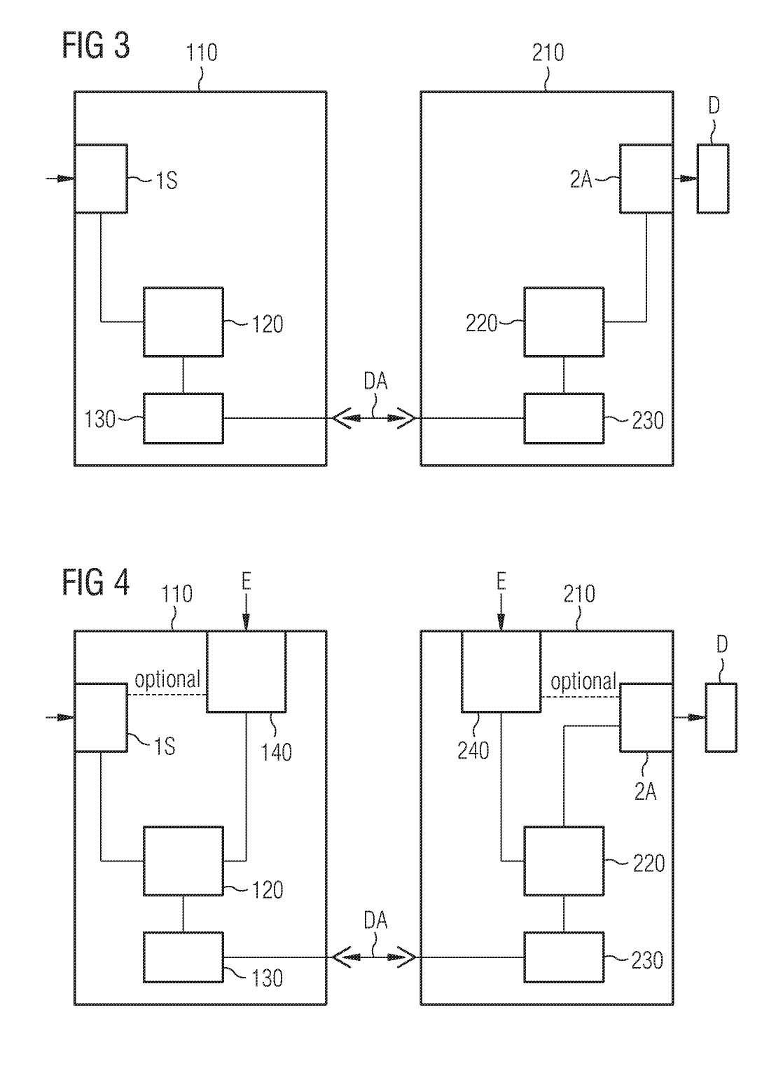

FIG. 3 a first and a second partial system with bidirectional data exchange,

FIG. 4 a favourable embodiment of a first and a second partial system,

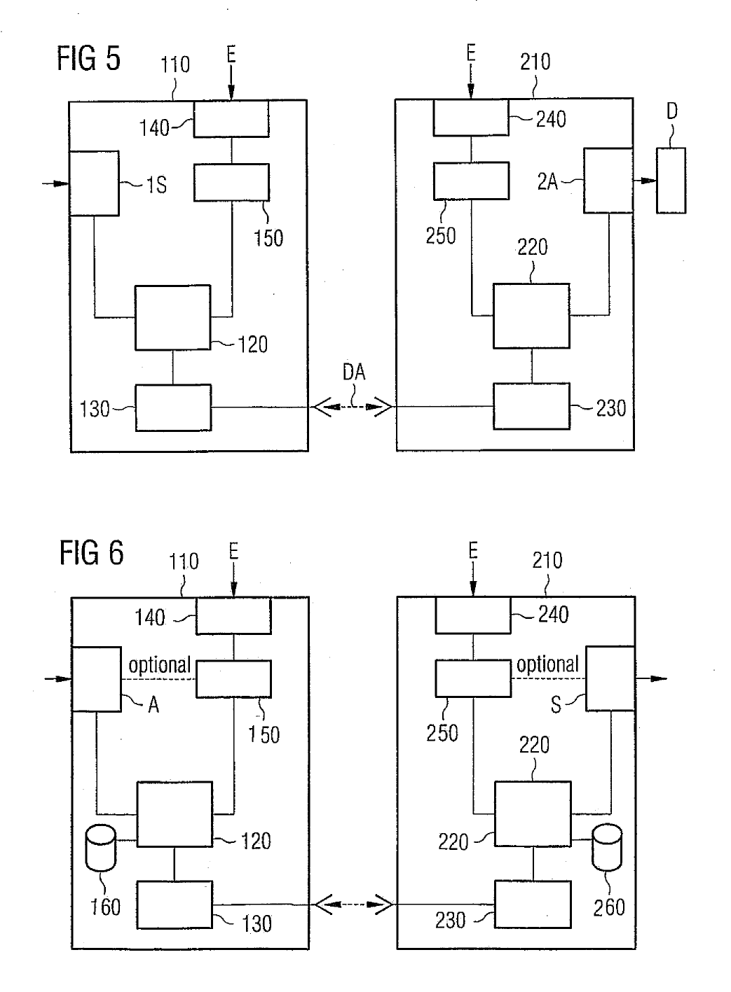

FIG. 5 an extended development of favourable embodiment of a first and a second partial system,

FIG. 6 a further extended development of favourable embodiment of a first and a second partial system,

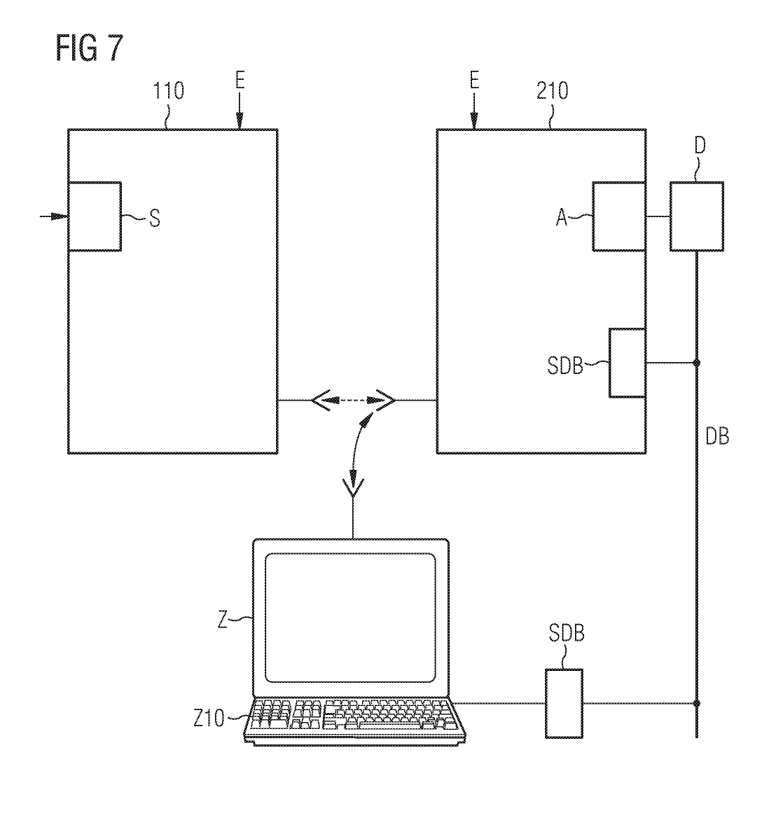

FIG. 7 a first and a second partial system with an interface to a data bus system.

FIG. 1 shows a schematic representation of a partial system 10 of a building equipment control system incorporating a sensor S and an actuator A. The sensor S is designed to acquire the current values related to a building unit. These include, for instance, the following parameters:

indoor temperature, indoor humidity, relative humidity, absolute humidity, IR heat sources, smoke, lighting level in a room, closure of windows or doors, locks on windows or doors, presence of persons in the room, solar radiation incident on the building, outside temperature, condition of a glass surface, freedom from damage of a glass surface, condition of mechanical, electromechanical or electrical control switches and many more.

All of these parameters can be converted by means of physical effects into electrical signals. Devices that generate an electrical signal from some of the parameters mentioned above are known, for instance, as photoelectric converters, thermoelectric converters, pyroelectric converters or magneto-electric converters, and are indicated as the sensor S.

A variety of sensor technologies, such as active or passive sensors, can be used for the sensor S of a partial system 10 according to the invention. Passive sensors here operate without external power supplies, and change passive electrical magnitudes without the need for electrical energy to be supplied. Passive sensors, in response to the physical parameters acting on them, create a separation of charges at a particular energy level. The energy level is a value that is indicative of the parameter that acts on them. For instance, a temperature difference at a thermocouple causes a separation of charges that is proportional to the magnitude of the temperature difference. Active sensors, in contrast, generate an electrical voltage or an electrical current, and themselves require electrical energy for their function. Sensors act as electrical signal sources. The electrical signal generated is an input signal for the processing unit 20.

A thermocouple that separates charges in response to a difference in temperature between two points can be taken here as an example for a sensor S. The magnitude of this charge separation provides, as an electrical voltage, a reference value for a specific temperature, and thereby an input signal that can be supplied for further processing to a processing device 20.

The same applies to the actuators, whereby the actuators always require at least one control signal from the processing unit. Coupling to an energy store is necessary for actuators that, in addition to a control signal, also require an operating voltage. Electromechanical, inductive, capacitative, pyroelectric, photoelectric, piezoelectric or thermoelectric devices are therefore appropriate as actuators or as sensors. Examples of actions that could be effected by such devices include lighting control by means of a dimmer, temperature control by means of a heating or air-conditioning unit, the provision of an alarm signal, or the transmission of information to a communication system such as telephone, mobile telephone or the Internet.

The physical parameters act here on the sensor S from the environment surrounding the partial system 10, or may operate directly by reaching a certain position in space or a certain magnitude. Parameters of this sort include, for instance, the temperature of a room, a locking mechanism for a window, a locking mechanism for outdoor, lighting equipment, or a light sensor for determining the level of light in the room.

The physical principles behind sensor S and actuator A are very similar, and are often merely inverted. Thus the application of an electrical voltage to a coil in an electromagnetic converter generates a magnetic field that exercises a mechanical force on a ferromagnetic body. Conversely, the action of a mechanical force or movement on the ferromagnetic core in the magnetic field of the electromagnetic converter generates an electrical voltage in the coil.

FIG. 2 illustrates a favourable embodiment of the partial system comprising a large number of favourable components. Thus FIG. 2 illustrates the partial system 10 with an energy converter 40. The energy converter 40 is coupled to the partial system 10, or is structurally connected to the partial system 10, and is designed to convert environmental energy in the form of light, heat, movement, electromagnetic waves or other environmental energy into electrical energy. The electrical energy obtained is supplied from the energy converter 40 to an energy storage unit 50. The energy storage unit 50 is designed to store electrical energy that has been obtained, and to release it as required to the electrically powered elements in the partial system 10. The energy store 50 consists, for instance, of an electrochemical energy store such as a battery or an accumulator, or of a charge store such as a capacitor.

Electrically powered elements here comprise the sensor S, if this is implemented as an active sensor S, the actuator A, along with the processing unit 20 and the signal transmission and reception unit 30. A data storage unit 60, which is provided in the favourable embodiment as shown in FIG. 2, also requires energy from the energy storage unit 50.

The data storage unit 60 is designed to store data for the processing unit 20. This includes, for instance, data that represents a history of the measured sensor values, or temporarily stored information that is to be transmitted to another partial system 10. According to FIG. 2, a functional building equipment unit D is provided with which the actuator A is coupled.

Depending on the purpose of the partial system and on the nature of the functional building equipment unit with which actuator A is coupled, actuators are employed that are suitable for affecting the functional building equipment unit and triggering an action there. The functional building equipment unit consists, for instance, of an air-conditioning unit or a heater for modifying the temperature of a room. The functional building equipment unit may also, for instance, consist of a roller blind or similar equipment to protect the entry of unwanted solar radiation.

The exact nature of the functional building equipment unit is only of subsidiary importance for the idea of the invention; in other words, the list just given above comprises only a small sample of the varied possibilities for functional building equipment units, and does not limit the range of applications of the partial system 10.

The processing device 20 is designed in such a way that the processing unit 20 can receive current values obtained by means of the sensor S and can process them. The current values are processed in accordance with a specified rule. Control signals are given to the actuator A depending, in accordance with this rule, on the current values; the actuator, depending on the principle of the actuator A, passes it on to the functional building equipment unit so that the desired parameter is controlled. For this purpose the actuator A is coupled to the functional building equipment unit.

The partial system 10 has a unique identifier, for instance a binary code, that distinguishes partial system 10 from other partial systems, thereby permitting partial system 10 to be identified. A signal transmission and reception unit 30 is coupled to the processing unit 20, and is designed to send information from the processing unit by means of a radio signal. This information includes the current values from the sensor S, control signals for the actuator A and/or other information such as an identification number for the partial system concerned. The unique identifier of the partial system is also added to the radio signal. Alternatively, a unique identifier for a receiver is added to the radio signal. The signal transmission and reception unit 30 is also designed to filter information out of a signal that has been received and to pass it on to the processing unit 20. The information received can take many forms. It can include information that is intended for partial system 10, in order to affect the actuator A. It can also, however, include information that is not directly intended for partial system 10 and which is transmitted onwards to other destinations by radio.

The energy converter 40, just like the sensor S or the actuator A, is based on an electro-physical principle that converts environmental parameters into electrical energy. Acting together with partial system 10, the energy converter 40 is designed to obtain energy as effectively as possible, so that parameters other than those determined by the sensor S, such as incoming light radiation, may be used to obtain energy. The energy converter 40 is selected appropriately for the place of use and for the form of convertible energy that occurs there most frequently. The energy converter 40, like the sensor S and the actuator A, operates according to an electromechanical, inductive, capacitative, pyroelectric, photoelectric, piezoelectric or thermoelectric principle or to a combination of these.

FIG. 3 illustrates an embodiment of a partial system according to the invention, in which a first partial system 10, referred to below as 110, and a second partial system 20, referred to below as 210, are coupled via a data exchange channel DA. The data exchange channel DA is comprised of a wireless transmission path, such as a radio channel. In this way, a large number of first partial systems 110 and a large number of second partial systems 210 can now be coupled to one another. Each individual processing unit of a partial system 110 or 210 has its own identifier, and this identifies partial system 110 or 210, distinguishing them from the other partial systems.

To conserve the electrical energy used in the partial systems 110 or 210, the processor of the partial system 110 or 210 is constructed in such a way that it can keep the entire partial system either in an “awake” state or in a “sleeping” state. The sleeping state here represents a standby status. In order to reach the active state from the standby condition, it is only necessary to send a wake-up signal, which the message transmission and reception equipment 30 receives and conveys to the processing unit of the partial system 10. This switches the partial system 110 or 210 into the active state. It is also, alternatively, possible to switch the partial system into the active phase by means of an input signal at the sensor S.

Messages that are passed from a first partial system 110 to the second partial system 210 are transmitted, for instance, by means of a radio channel in accordance with a specifiable protocol. Alternative wireless transmission paths include, for instance, infrared signals or other known wireless transmission paths operating in accordance with various rules. The rules of the radio protocol also ensure that the collision of messages resulting from the simultaneous transmission and reception within a network formed of several partial systems 10 can be avoided. If a network is composed, for instance, of n partial systems, then an item of information at any of the partial systems 110 is fed into the network where it is routed or relayed through a large number of partial systems in the network, finally reaching partial system 210. A favourable aspect of this is that a message can be transmitted over large distances whilst only using low transmission energies at the individual partial systems 110 and 210.

Partial system 110 and partial system 210 differ in that partial system 110 incorporates a sensor 1S while partial system 210 incorporates and actuator 2A. The sensor 1S determines physical values from its environment, and supplies these to the processing unit 120. The processing unit 120 then supplies this value to the signal transmission and reception unit 130 which transmits the value over the data exchange channel DA. The signal transmitted is received by the signal transmission and reception unit 230 of the second partial system 210. The second partial system 210 is physically distant from the partial system 110. The signal transmission and reception unit 230 passes the information that was impressed upon the received signal to the processing unit 220. In the light of this information and of specifiable rules stored in the processing unit 220, this determines a value that is supplied as a signal to the actuator 2A. By means of this signal the actuator 2A, through a functional building equipment unit that is coupled to it, causes a change in an observed parameter such as, for instance, a rise in the room temperature.

FIG. 4 schematically illustrates a network comprised of partial systems 110 and 210, whereby each of the partial systems 110 and 210 incorporates an energy converter 140 or 240. The energy converter 140/240 converts environmental energy into electrical energy, and supplies partial system 110 or partial system 210, including their processing units, signal transmission and reception units and actuators or sensors, with electrical energy. The energy converters 140/240 make the individual partial systems independent of other energy sources such as batteries that have to be replaced at regular servicing intervals. If no energy is available at one of the partial systems, or if the energy is not of sufficient quantity, the information is conveyed through neighbouring partial systems. If one partial system temporarily drops out for energy reasons, therefore, there is no negative effect on the network as a whole.

FIG. 5 schematically illustrates the arrangement of FIG. 4. However it differs from the arrangement of FIG. 4 in that the energy converter 140 or 240 is coupled to an energy store 150 or 250. The energy store 150 or 250 is thus able temporarily to store electrical energy obtained from environmental energy, making this available when required to the components of partial systems 110 or 210.

In this embodiment, it is possible to supply the power to a network consisting of a large number of such partial systems 110 or 210 entirely on the basis of environmental energy. Together with energy-saving operating states such as the “sleep” condition, and the wake-up signals, triggered by input signals at the sensor 1S or at the communication unit, that are therefore necessary, secure, sustained operation of the network of partial systems 110/210 can be achieved, even over a long period of time.

FIG. 6 illustrates schematically a network of partial systems 110/210 that have been favourably further developed in that the processing unit 120/220 is coupled to data storage equipment 160/260. The data storage equipment makes it possible to store specified or actual values temporarily, or also to store data that has been received but which, because of the kind of problem that has just been outlined, cannot yet be relayed to a neighbouring communication station. In this way a network of partial systems A10 and B10 is created in which information is not only be relayed, transmitted and received but is also temporarily stored.

FIG. 7 illustrates a favourable embodiment having a central unit Z that is coupled to the network. The central unit Z consists, for instance, of a computing device which, with its display, permits the automatic building equipment to be controlled. FIG. 7 also shows an interface SDB to a wired data bus system DB. This interface is located in a partial system positioned, for instance, physically close to a wired data bus system. These could, for instance, be those partial systems that incorporate actuators and which therefore operate on the functioning units of the building equipment and which may therefore be structurally integrated into them. The functional items of building equipment often rely on power from the electrical mains, and are therefore often positioned not far from central cable connections. The interface to the data bus system provides a favourable combination of radio transmission and wired data transmission. Radio transmission saves the need for expensive installations and long cable routes, permitting data to be routed through the network consisting of the individual partial systems and thereby transmitted. Coupling to the bus system allows data to be transmitted over other routes, for instance to other buildings on a site without creating a need for additional installation work.

A network as described above also permits other systems to be integrated into the network and thereby into the network communication. This permits data to be exchanged with other systems, thereby allowing further processing of the data. This only requires the wireless data transmission path and the identification method to be matched. In this way, for instance, a central control unit can be integrated into such network, giving a user of the building control system a visual display of information about the status of all the sensors, all the actuators, and all the measurements taken at various locations. The central control unit integrated into the network also permits control of the individual partial systems, along with centrally implemented changes to the specified values. For this reason a user interface Z10 is provided giving the user not only an overview of the current sensor data but also acting as a tool by which the user can specify values to the individual partial systems. In addition it is possible to integrate a data bus system for data exchange with other parts of the building or equipment. This only requires an interface for transferring the data from the network to the data bus system; this interface can be installed at one of the partial systems or at the central control unit.

Although partial systems having the same embodiment have always been grouped together in networks above, this is not an essential requirement. A heterogeneous mixture of partial systems of various embodiments allows each partial system in a network to be adapted to the particular purpose and/or location of its use.

### LIST OF REFERENCE CODES

0 Sensor
A Actuator
10 Partial system of a building equipment control system
20 Processing unit
30 Signal transmission and reception unit
40 Energy converter
50 Energy store
60 Data storage
110 First partial system
15 Sensor of the first partial system
1A Actuator of the first partial system
DA Data exchange channel
D Functional unit of building engineering
120 Processing unit in the first partial system
130 Signal transmission and reception unit in the first partial system
140 Energy converter in the first partial system
150 Energy store in the first partial system
160 Data store of the first partial system
210 Second partial system
2S Sensor of the second partial system
2A Actuator in the second partial system
220 Processing unit in the second partial system
230 Signal transmission and reception unit in the second partial system
240 Energy converter of the second partial system
250 Energy store of the second partial system
260 Data store in the second partial system
Z Central control unit
Z10 User interface on the central control unit
DB Data bus system
SDB Interface to the data bus system

1. A building equipment control system with at least one partial system comprising:
a sensor for acquisition of environmental physical conditions and/or an actuator for providing a signal to a functional building equipment unit, wherein the sensor and the actuator are coupled to a processing unit that processes the signals and/or generates an actuator signal; and
a wireless information transmission and/or receiving unit that is coupled to the first processing unit and is designed to transmit and/or receive sensor signals and/or actuator signals.

2. The building equipment control system according to claim 1 wherein
the partial system is configured to perform bidirectional data exchange with at least one further partial system by means of the wireless signal transmission and reception unit.

3. The building equipment control system according to claim 1, wherein
the partial system includes an energy converter that converts non-electrical environmental energy into electrical energy.

4. The building equipment control system according to claim 1, wherein
the partial system includes an energy store that is provided in order to store electrical energy from the energy converter.

5. The building equipment control system according to claim 1, wherein
the partial system includes a data storage unit with which the processing unit is coupled.

6. The building equipment control system according to claim 1, wherein
the actuator and/or the sensor is coupled to a functional building equipment unit.

7. A building equipment control system according to claim 1, wherein
a central unit is provided that performs bidirectional data exchange with at least one partial system.

8. The building equipment control system according to claim 7, wherein
the central unit includes a user interface adapted to inform a user of the operating states of individual building equipment units and/or to control them by the user.
